(19) United States
(12) Patent Application Publication
(10) Pub. No.: US 2006/0053094 A1
(43) Pub. Date: Mar. 9, 2006

(54) Automated information technology infrastructure management

(76) Inventors: Prasad V. Ravi, Evanston, IL (US); Prasad K. Rao, Vernon Hills, IL (US); William E. Jensen, Madison, WI (US); Richard A. Smith, Cottage Grove, WI (US)

Correspondence Address: FOLEY & LARDNER LLP, 150 EAST GILMAN STREET, P.O. BOX 1497, MADISON, WI, 53701-1497, US

(21) Appl. No.: 10/934,660

(22) Filed: Sep. 3, 2004

(51) Int. Cl. G06F 17/30

(52) U.S. Cl. 707/3

(57) ABSTRACT

A self-service, automated information technology infrastructure management system is provided. The method includes receiving minimal information pertaining to an information technology infrastructure from a user at a web portal, automatically gathering additional infrastructure information using the minimal information received from the user, and automatically monitoring the information technology infrastructure by collecting infrastructure data and examining the collected infrastructure data for a deviation from a normal operating condition.

### BACKGROUND OF THE INVENTION

1. Field of the Invention

The present invention relates generally to the monitoring and the management of information technology (IT) infrastructures. More specifically, the present invention relates to an automated IT infrastructure management system.

2. Description of the Related Art

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

Infrastructure management describes the management and monitoring of communication circuits, servers, applications, databases, development environments, user interfaces, operating systems, hardware such as local area network (LAN) equipment and wide area network (WAN) equipment, network-enabled Personal Digital Assistants (PDAs) and Smartphones, and any other underlying technological components that constitute an organization's systems architecture. Some of the processes involved with infrastructure management include setup, configuration, data collection, data analysis, security monitoring, user notification when a problem or potential problem arises, and the provision of status reports. These services generally are product-based that may be purchased directly from a product vendor or obtained through management service providers (MSPs).

Product-based solutions sold by vendors typically are either software solutions or pre-packaged software/hardware solutions and can be subdivided into four categories: (1) framework solutions, (2) mini-framework solutions, (3) toolkits, and (4) pre-integrated solutions. MSPs typically use one or more solution from these product vendors and provide IT infrastructure management services on a contract and per device basis.

Framework solutions include support for most aspects of IT infrastructure, including LAN/WAN, servers, applications, software distribution, and security. They are generally extremely difficult to integrate (for example, the Tivoli product has 58 modules, and the Hewlett-Packard OpenView Management Software has 62 modules) and expensive.

Mini-framework solutions provide less comprehensive management of IT infrastructure as compared to the framework solutions covering only a subset of LAN/WAN, servers, and applications. The solutions are less difficult to use, but are still expensive and often require a full time person to monitor the IT infrastructure performance.

Toolkits cost far less than framework or mini-framework solutions, but still require days of setup time and continuous maintenance of the management infrastructure itself. Additionally, toolkits provide extensive functionality in very specific areas such as management of web servers, but are severely limited in their functionality and comprehensiveness from an overall IT infrastructure perspective.

Pre-integrated solutions have some combination of LAN/WAN, servers, applications, asset, security, and performance management functionality typically provided as part of an appliance. Although much easier to use than any of the previously described solutions, they still are expensive and still require the user and/or reseller to manage the management infrastructure on an ongoing basis.

Current IT infrastructure management tools require extensive setup, installation, configuration, and maintenance of both software and hardware by experienced engineers. Setup requires the purchase of IT infrastructure management software and compatible hardware. Yearly maintenance contracts for both the software and hardware are needed to allow for bug fixes, new features, and version updates. Software support for the operating system (e.g. UNIX, Windows) is required as well. Additionally, setup may require multiple servers, such as database servers or redundant servers, depending on the size of the IT infrastructure and the data being collected.

Installation and configuration require the knowledge of expert network, system, and application engineers at a considerable expense. Configuration involves customizing the management software application to collect data from each infrastructure component on the network. Configuration may also entail configuration of the individual infrastructure components to allow for management software and hardware interaction. Generally, these configurations are done manually by trained personnel.

Ongoing maintenance of the software and hardware is required to ensure the system is functioning well. Again, expert help is needed for this ongoing maintenance at a considerable expense to the user. As infrastructure components change on a network, a frequent occurrence on IT networks, the management software and hardware needs to be configured to reflect such changes. Again, the maintenance operations generally are done manually by trained personnel.

Additionally, current IT infrastructure management tools provide limited mobile functionality with only simple paging, e-mail, and telephone notification services. Thus, the ability to comprehensively manage IT infrastructure through mobile devices such as wireless PDAs and Smartphones is unavailable. Further, existing mobile solutions do not provide a way to display a topology map of the user network and to “drill down” to the detailed level of individual components.

As a result of these various and complex problems, IT infrastructure management technology is severely underutilized in most organizations, resulting in much more reactive approaches to problem resolution. As might be expected, this leads to network resources being unavailable for long periods of time, resulting in substantial losses in business productivity.

Thus, there is a need for a low cost, comprehensive IT infrastructure management tool that allows for easy, on demand setup. Further, there is a need for an IT infrastructure management tool that is easily integrated into the business operations. Further still, there is a need for an IT infrastructure management tool that does not need to be extensively managed by experts in the field.

### SUMMARY OF THE INVENTION

An exemplary embodiment relates to a method for self-service, automated information technology infrastructure management. The method includes, but is not limited to, receiving minimal information pertaining to an information technology infrastructure from a user at a web portal, automatically gathering additional infrastructure information using the minimal information received from the user, and automatically monitoring the information technology infrastructure by collecting infrastructure data and examining the collected infrastructure data for a deviation from a normal operating condition.

Another exemplary embodiment relates to a system for providing self-service, automated information technology infrastructure management. The system includes, but is not limited to, a communications interface that receives minimal information from a user, a setup and configuration module that automatically gathers additional infrastructure information using the minimal information received from the user, and a monitoring and management module that automatically collects infrastructure data and automatically examines the collected infrastructure data for a deviation from a normal operating condition.

Other principal features and advantages of the invention will become apparent to those skilled in the art upon review of the following drawings, the detailed description, and the appended claims.

### BRIEF DESCRIPTION OF DRAWINGS

The preferred embodiments will hereafter be described with reference to the accompanying drawings, wherein like numerals will denote like elements.

FIG. 1 is a flow diagram depicting a broad overview of exemplary automated operations in an IT infrastructure management system.

FIG. 2 is a diagram depicting at least a portion of automated setup and configuration in an automated IT infrastructure management system.

FIG. 3 is a diagram depicting exemplary monitoring and maintenance modules in an automated IT infrastructure management system.

### DETAILED DESCRIPTION OF EXEMPLARY EMBODIMENTS

Exemplary embodiments of an automated IT infrastructure management system solve prior IT infrastructure monitoring and management problems by automating the setup, configuration, maintenance, monitoring, notification, and reporting of IT infrastructure management. These exemplary embodiments may be offered to the user as a service on the Internet using a self-service web portal. In addition, the user may interact with this service using various devices that include, but are not limited to, a wireless PDA or a Smartphone to provide timely access to critical network information.

Automated IT infrastructure management provides inexpensive services by removing the need for manual setup, manual configuration, and manual monitoring and maintenance. By automating these steps, there is no longer a need for costly engineers to continuously maintain the management system. As a result of significantly reduced costs, a wide range of companies have access to automated IT infrastructure management. Additionally, automation provides for almost instantaneous commencement of service. Thus, there is no need to wait days or weeks for installation, configuration, and setup of hardware and software. A discussion of the figures exemplifies an automated system that supports IT infrastructure management.

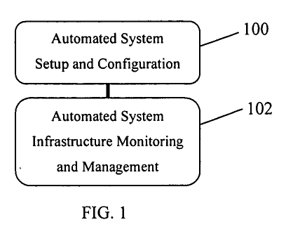

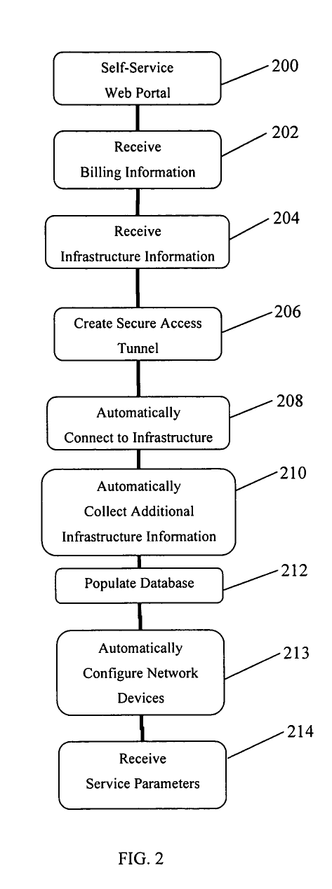

FIG. 1 illustrates exemplary operations in an automated IT infrastructure management system. In an operation 100, the automated IT infrastructure management system provides automated setup and configuration. With automated setup, users are able to sign up for service through a web or a network portal. The user provides limited infrastructure and billing information, and the automated system completes other necessary operations. Automated setup allows a user to obtain on demand service that can be activated in a matter of minutes. Using automated configuration, the infrastructure components may be configured through a web or network portal. A more detailed explanation of operations associated with automated setup and configuration is discussed with reference to FIG. 2.

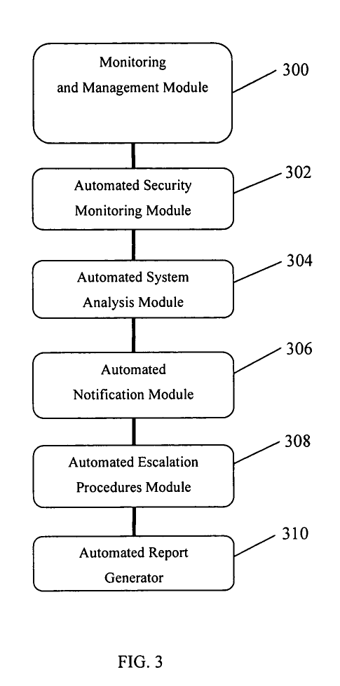

After setup and configuration are complete, the infrastructure components may be automatically monitored for any problems or potential problems in an operation 102. If a problem or potential problem is detected, the user is automatically notified and escalation procedures may be initiated. In addition to notification, monitoring reports may be automatically generated and sent to the user at a pre-set frequency. Such reports may contain problem summaries, information on infrastructure performance, infrastructure security issues, etc. A more detailed discussion of an automated maintenance and monitoring system is discussed with reference to FIG. 3.

FIG. 2 illustrates automated setup and configuration operations in accordance with an exemplary embodiment of an automated IT infrastructure management system. The automated infrastructure management system can be run through a self-service web portal on the Internet or other LAN or WAN. A web portal is a web page designed to allow different users to tailor and to aggregate content according to individual preference. The self-service web portal 200 allows a user to sign up for the services at the website, to provide minimal information to the provider about the user's infrastructure, to select the type(s) of service, the variables to be monitored, alarm thresholds, etc.

A user may provide, through the web portal, the user's billing information. In an operation 202, the web portal receives the billing information. Online billing can be quick and easy for the user. Additionally, online billing allows the service provider to validate the user's billing information before commencing with service setup. Multiple payment mechanisms may be supported online, including credit cards and company purchase orders. In an alternative embodiment, the user may be provided with a telephone number such that the user may submit billing information verbally. In another alternative embodiment, the user may be provided with an address such that the user may submit a check or a money order to the provider.

In addition to billing information, the user may also provide, through the web portal 200, minimal information about the user's various infrastructure components. In an operation 204, the web portal receives the minimal information. The minimal information includes, but is not limited to, general infrastructure information and network access information. For example, the minimal information may include LAN and WAN device and server component types and versions, applications supported at the device and/or server and the application versions, Internet Protocol (IP) addresses to access the IT infrastructure components, the type of service provided at each component, etc. The type of service may include, but is not limited to, SMTP, IMAP, HTTP, SNMP Read and Write strings, etc.

In order to monitor and manage the infrastructure, the automated system maintains secure access to each of the infrastructure components. Remote access can be achieved over the Internet, over a modem, or using other private access methods. To ensure security, the web portal creates a secure access tunnel in an operation 206. The secure access tunnel, that may be a secure Internet protocol virtual private network (IPSec VPN), can be established at the perimeter of the user's network using a firewall/VPN concentrator.

At operation 208, the web portal 200 automatically connects to the infrastructure components on the network. Once connected, the service automatically collects detailed information on each infrastructure component in an operation 210. The collected information may include, but is not limited to, the number and type of different modules on a network device (switch, router, server, desktop, printer, appliance, PDA, Smartphone, etc.), the number and type of network ports, the type and version of operating system software, the number and type of applications and processes, and the number and type of communication links/circuits. This information is used to populate a database specific to the user's IT infrastructure in an operation 212. The collected information may be used by the system to automatically configure the user's network devices to be interoperable with the provider's web or network portal. The information collector and database may be built by any means sufficient to collect and to store infrastructure information including, but not limited to, my structured query language (mySQL), Oracle databases, etc. The collected information is used, in an operation 213, to automatically configure the network devices that make up the IT infrastructure.

To complete the setup and configuration processes, the user may also specify service parameters. In an operation 214, the web portal receives the service parameters. The service parameters may include, but are not limited to, the type of service(s) to be provided. For example, a user may only desire infrastructure management as opposed to security monitoring and management. The service parameters may also include variables to be monitored, the monitoring frequency, notification times, notification means, report frequency, report contents, reporting means, normal operating condition thresholds, alarm thresholds, escalation procedures, etc. The web portal 200 may provide the user with a list of default values for each of these variables. The user may choose to implement the service based on the default parameters or to modify the service plan to meet the user's individual needs.

FIG. 3 illustrates a flow diagram depicting exemplary monitoring and maintenance operations in an automated IT infrastructure management system. In an operation 300, an automated system starts the automated infrastructure monitoring and management. The automated system may include, but is not limited to, an automated security monitoring module 302, an automated system analysis module 304, an automated notification module 306, an automated escalation procedure module 308, and an automated report generator 310.

Devices such as firewalls, virtual private network (VPN) concentrators, intrusion detection service (IDS) devices, intrusion detection and prevention (IDP) devices, desktops, laptops, servers, PDAs, and Smartphones all may be monitored to ensure that the network is secure. The service may also provide automated security scanning of the IT infrastructure for security problems. Automated report generator 310 may provide recommendations for security fixes.

To monitor the infrastructure and detect problems, the automated system analyzes the infrastructure components using the automated system analysis module 304. The automated system analysis module 304 may provide analysis at a designated time interval that may be a default value or a value specified by the user as part of operation 214. The automated system analysis module 304 collects data on the infrastructure and examines the collected data for deviations from normal operating conditions. The thresholds for normal operating conditions and alarm conditions may be based on default values or values specified by the user as part of operation 214. Also, for very large networks or for networks where a substantial amount of data should be collected, a hardware appliance may be built to be installed on the user premises.

Upon discovering deviations from normal infrastructure operating conditions, the automated notification module 306 may automatically notify the user of the deviations. A user may be notified using email, using a landline telephone, using a cellular telephone, using a Smartphone, using a PDA, etc. Additionally, a user may check the web portal 200 for notifications. The notification itself informs a user of a problem or a potential problem so that a user may take appropriate action if necessary. The automated notification module 306 may provide the user with a topology map of the network that includes the operational details of individual infrastructure components.

After receiving a notification of the problem or the potential problem, the user may interact with the automated system to resolve the problem or the potential problem. However, if the user does not interact with the system within a designated time period after a notification is sent, the automated escalation procedure module 308 may automatically implement escalation procedures. An escalation procedure specifies the personnel, systems, and time frames by which further notification can occur if there has been no response, a delayed response or an inadequate response to the user notification. The escalation procedure may also be activated if certain thresholds are reached, for example, network traffic at a particular communication link, type of server, or application exceeds a specified level or if certain time thresholds have been exceeded. The user may specify escalation procedures to ensure that problems or potential problems are addressed in a timely fashion.

The automated report generator 310 automatically generates reports and distributes them to the user. The reports may provide details relative to a specific incident, may provide summaries of incidents, may provide information to a lack of an incident during a specified time period. The frequency of report generation may be set by default or may be specified by the user. The frequency may be time dependent, for example daily or weekly, or may be incident dependent. Reports may be sent to the user using email or other means made available to the user through the web portal 200.

As discussed with reference to FIG. 2, the user may communicate setup and configuration information to the automated system through a web portal. However, the web portal may not be the most efficient method for communicating notification and report information from the automated system to the user.

The user may specify the method of receiving notifications and/or reports at operation 214. The user may specify a personal computer (PC), a landline or a cellular telephone, a PDA, a Smartphone, etc. Using a PC the notifications and/or reports may be received through email, by accessing the web portal, or by receiving a message through a messaging service. Thus, if a PC or a telephone is desired for receiving the notifications and/or reports, the user may be prompted to provide a phone number and/or an email address during the initial setup at operation 100. If a user prefers to receive notifications and/or reports using a PDA or a Smartphone, the user may download a module and install it on the PDA and/or Smartphone.

It should be understood that the above described embodiments are illustrative only, and that modifications thereof may occur to those skilled in the art. For instance, other technologies that may be effective for implementing embodiments include Linux, distributed agent technology, and advanced compression techniques. The invention is not limited to a particular embodiment, but extends to various modifications, combinations, and permutations that nevertheless fall within the scope and spirit of the appended claims.

What is claimed is:

1. A method for self-service, automated information technology infrastructure management, the method comprising:
receiving minimal information pertaining to an information technology infrastructure from a user at a web portal;
automatically gathering additional infrastructure information using the minimal information received from the user; and
automatically monitoring the information technology infrastructure by collecting infrastructure data and examining the collected infrastructure data for a deviation from a normal operating condition.

2. The method of claim 1, wherein the minimal information includes access information to remotely access the information technology infrastructure.

3. The method of claim 2, wherein the access information includes an Internet protocol address for an infrastructure component.

4. The method of claim 1, wherein the minimal information includes general infrastructure information.

5. The method of claim 1, further comprising specifying an escalation procedure.

6. The method of claim 1, wherein the additional infrastructure information is gathered using a secure access tunnel.

7. The method of claim 1, further comprising receiving a method for sending a notification to the user.

8. The method of claim 7, wherein the method is selected from the group consisting of a telephone, an email, a messaging service, and a network.

9. The method of claim 7, wherein the notification provides information about an infrastructure component.

10. The method of claim 1, further comprising generating a report.

11. The method of claim 10, further comprising receiving a method for sending the report to the user.

12. The method of claim 11, wherein the method is selected from the group consisting of a telephone, an email, a messaging service, and a network.

13. The method of claim 1, wherein the infrastructure monitoring comprises automated security monitoring.

14. The method of claim 1, wherein the infrastructure monitoring comprises automated escalation procedures.

15. The method of claim 1, further comprising configuring the information technology infrastructure.

16. A system for providing self-service, automated information technology infrastructure management, the system comprising:
a communications interface that receives minimal information from a user;
a setup and configuration module that automatically gathers additional infrastructure information using the minimal information received from the user; and
a monitoring and management module that automatically collects infrastructure data and automatically examines the collected infrastructure data for a deviation from a normal operating condition.

17. The system of claim 16, wherein the minimal information includes access information to remotely access the information technology infrastructure.

18. The system of claim 17, wherein the access information includes an Internet protocol address for an infrastructure component.

19. The system of claim 16, wherein the minimal information includes general infrastructure information.

20. The system of claim 16, wherein the additional infrastructure information is gathered using a secure access tunnel.

21. The system of claim 16, wherein the communications interface receives a method for sending a notification to the user.

22. The system of claim 21, wherein the method is selected from the group consisting of a telephone, an email, a messaging service, and a network.

23. The system of claim 21, wherein the notification provides information about an infrastructure component.

24. The system of claim 16, wherein the monitoring and management module generates a report.

25. The system of claim 24, wherein the communications interface receives a method for sending the report to the user.

26. The system of claim 25, wherein the method is selected from the group consisting of a telephone, an email, a messaging service, and a network.

27. The system of claim 16, wherein the monitoring and management module further comprises automated security monitoring.

28. The system of claim 16, wherein the monitoring and management module further comprises automated escalation procedures.

29. The system of claim 16, wherein the setup and configuration module configures the information technology infrastructure.
